(19) United States
(12) Patent Application Publication
(10) Pub. No.: US 2012/0023793 A1
(43) Pub. Date: Feb. 2, 2012

(54) SIGNAGE VISIBLE THROUGH THERMAL-IMAGING CAMERA

(76) Inventor: John S. WILLIAMS, Canton, GA (US)

(21) Appl. No.: 13/171,674

(22) Filed: Jun. 29, 2011

Related U.S. Application Data
(60) Provisional application No. 61/368,122, filed on Jul. 27, 2010.

(51) Int. Cl. G09F 13/20; G09F 13/16; G09F 7/16; G09F 7/00

(52) U.S. Cl. 40/542; 40/584; 40/582; 40/594

(57) ABSTRACT

A sign including a panel having at least one indicator-shaped aperture therethrough from side to side. The panel includes a backing secured to a first surface of the panel. The backing can be made of fire-retardant material. A sheet can be secured to a second surface of the panel. The sheet can be made of fire-retardant material. A volume of fluid can be contained within a space defined by the at least one panel aperture, the backing and the sheet.

### CROSS-REFERENCE TO RELATED APPLICATION

This application claims the priority benefit of U.S. Provisional Patent Application Ser. No. 61/368,122, filed Jul. 27, 2010 which is hereby incorporated herein by reference.

### BACKGROUND OF THE INVENTION

Being a firefighter is a highly dangerous job. Firefighters often are asked to enter burning buildings and navigate within large, open spaces that are filled with thick smoke. As a result, oftentimes, during the course of a particular fire rescue operation, one or more firemen lose their lives. Most frequently, this loss of life occurs because the firemen become lost and/or are unaware of the escape route due to unfamiliar territory or simply signage that cannot be interpreted during fire and smoke conditions.

A 1999 fire killed six firemen in Wooster, Mass. Following this fire, investigators from the National Institute of Occupational Safety and Health (NIOSH) concluded in an investigative report to determine how to minimize the risk of similar occurrences. Example findings included that fire departments should ensure that inspections of vacant buildings and pre-fire planning are conducted. Such investigations should cover all potential hazards, structural building materials (type and age), and renovations that may be encountered during a fire. With such information, the Incident Commander will have the necessary structural information to make informed decisions and implement an appropriate plan of attack.

NIOSH further stated that fire departments should ensure that Incident Command always maintains close accountability for all personnel at the fire scene. And, the departments should possibly use guide ropes/tag lines securely attached to permanent objects at entry portals and place high-intensity floodlights at entry portals to assist lost or disoriented fire fighters in emergency escape.

However, visibility within fire environments and assistance with fire rescue escape routes remains a problem.

### SUMMARY OF THE INVENTION

The present invention relates to a signage system for escaping buildings comprising Type II construction. This tool can be used by a local fire department and their Incident Command system. In example embodiments, the tool comprises at least one, and preferably a series of, placards. Each placard has a fire-retardant material front layer comprising photo-illuminescent and light-reflective properties. The placard has a flat metallic interior panel structure comprising at lest one alphanumeric cutout shape to create at least one aperture between a front and back surface of the panel. Each placard has a fire-retardant material rear backing layer adhering to the rear surface of the panel. Between the front layer and the rear layer, a pocket of air is formed and sealed within the shape of the alphanumeric cutout shape of the panel. During conditions of increased temperature, such as during a fire, this pocket of air reaches a different temperature from the interior panel and thus can be visibly seen through thermal-imaging cameras.

Each placard is mounted in a specific location within a building and will provide certain information. Example information comprises a location number and a distance from the particular location to an exit in at least one direction. Preferably, upon installation of the placards, a master plan document is formed to act as a pre-plan map. This map can be used by firemen (e.g., Incident Command) to navigate a building under dangerous circumstances and reduce the potential that a fireman will become lost.

### BRIEF DESCRIPTION OF THE DRAWINGS

FIG. 1 is a front planar view of a first example placard.

FIG. 2 is a planar view of a second example placard.

FIG. 3 is a planar view of a third example placard.

FIG. 4 is an exploded perspective view of the example placard shown in FIG. 1.

FIG. 5 is an example pre-plan schematic of a building with a plurality of the example placards of FIGS. 1-4 installed at strategic locations.

FIG. 6 is a top view of the example placard of FIG. 1.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The invention is a sign/placard or system thereof used to guide people (e.g., firemen) to safety during emergency situations in large structures. An example embodiment comprises a sign or placard, or plurality of signs or placards that can be mounted at designated locations and positions throughout a structure. In typical embodiments, the sign or placard comprises a length of between about ten and fourteen inches. The internal panel 68 comprises a rigid metallic layer comprising a front surface and a back surface. Preferably, the metallic material comprises high heat capacity characteristics. A preferable example material is aluminum. And, the sign or placard can comprise one end with a pointed arrow-shape or both ends with pointed arrow-shapes.

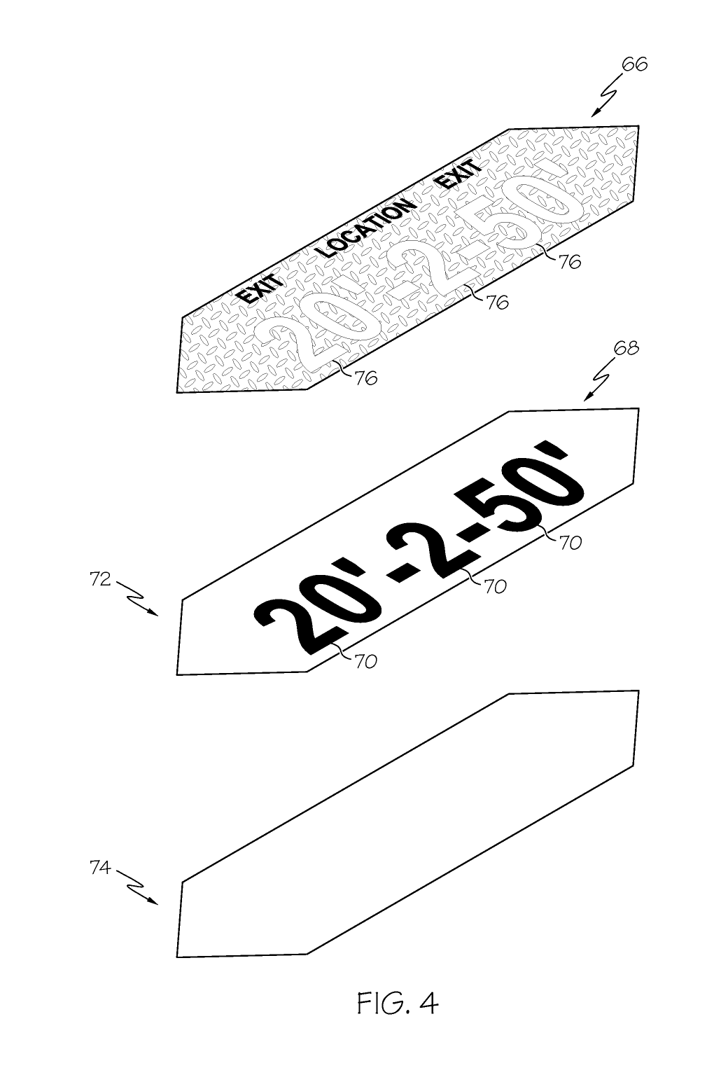

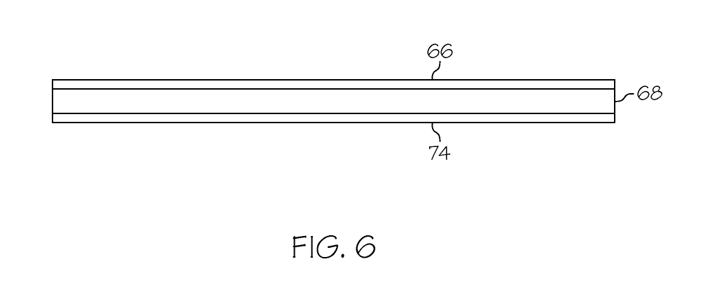

As shown in FIGS. 4 and 6, the example placard comprises an internal panel 68 that comprises at least one indicator shape 70 cut out to form an aperture. The indicator apertures 70 can comprise alphanumeric indicators/characters indicating a designated location of the particular sign or placard, and the distance to an exit in a particular direction. Preferably, an alphanumeric character, or characters, indicating the placard location is centrally located on the example sign or placard, and an alphanumeric character, or characters, indicating distance to an exit is located on one or both sides near an arrow-shaped aperture that is formed similarly by the sign for visibility by thermal-imaging equipment. The alphanumeric character, or characters, can be arranged to read horizontally along the sign or placard. Alternatively, the alphanumeric character, or characters, can be arranged to read vertically from top to bottom for use with storage racks

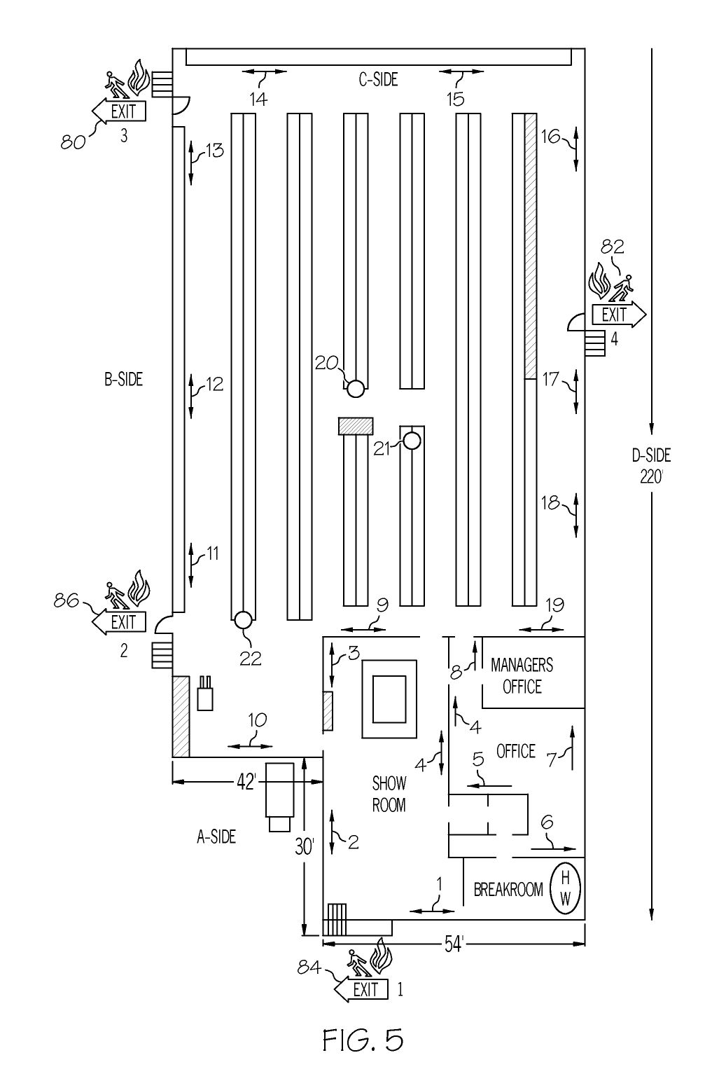

The internal panel 68 can alternatively comprise one or more arrow-shaped apertures pointing in a designated direction. As mounted to the building structure, the sign or placard can indicate the direction of a nearest exit within the structure. A preferred embodiment alternatively comprises a sign or placard comprising two arrow-shapes, or alternatively arrow-shaped apertures, pointing in opposite directions; each to indicate one of two possible exits from the structure. Example structures can include a building, a warehouse, and any alternative structure that comprises enclosed interiors and one or more exits from the structure. For example, the building shown in FIG. 5 comprises multiple exits, rooms and obstructions.

The example placard further comprises a backing layer 74 of fire-retardant material secured to a back surface of the internal panel 68 with fire-retardant adhesive. An example flame-retardant material secured to the back surface of the metallic material is Adhesive Transfer Tape F-9465PC manufactured by 3M®. Alternatively, or in addition, alphanumeric character indicators can be secured to the outwardly-facing surface of the photo-illumination material. These indicators can comprise fire-retardant tape or stickers and are preferably solid colors.

The example placard also comprises a front cover sheet 66 of fire-retardant material secured to a front surface of the internal panel 68 with fire-retardant adhesive. This front material 66 can comprise material made of photo illuminescent vinyl. The example photo-illuminescent vinyl material preferably glows in dark light and can be viewed during early stages of an emergency. The example, reflective material can be viewed in any light condition, as well as heavy smoke, with the assistance of a flashlight. The example photo-illuminescent material also preferably is fire retardant and heat resistant. An example photo-illuminescent material is manufactured by FotoLum™. The FotoLum™ G-40 Series, Vinyl Series and G-100 Series have illumination characteristics that exceed industrial standards and comprise reflective characteristics incorporated in a particular pattern. The reflective characteristics can be provided by reflective text, zig/zag or tread-plate pattern manufactured by 3M®.

The adhesive layer for securing the backing layer 74 and the front material 66 can be a double-sided adhesive to also stick to a mounting surface. Alternatively, the backing layer 74 can be a double-sided material with fire-retardant adhesive on each side. This double sided adhesive property allows the front layer 66 to stick to the internal panel 68 front surface. And, a second piece of double sided adhesive layer sticks between the backing layer 74 and the internal panel 68 back surface. A further adhesive layer can be secured to the backing layer 74 to allow the sign assembly to be secured to a wall or alternative surface. The example Adhesive Transfer Tape F-9465PC manufactured by 3M® can be double sided and used to adhere to both the front and back surfaces of the metallic internal panel. In alternative embodiments, other fire-retardant fastening elements can be used such as screws or other types of epoxy.

Pockets of air are thereby contained within the indicator shaped apertures 70 and withheld between the rear surface fire-retardant material layer 74 and the front surface fire-retardant material layer 66. Upon elevation of surrounding temperature (e.g., during a fire), the air trapped within the apertures 68 obtains different temperature from the internal panel 68. The example air pockets outlined by the apertures 68 can be viewed by currently-available thermal imaging camera when the air contained within the pocket reaches a certain temperature above room temperature. Firemen currently use thermal imaging cameras to identify persons trapped within buildings during dark-light situations, so suitable equipment is already carried by many firemen. During a fire, the air throughout the building will have an elevated temperature from normal, and the air contained within the placard air pocket will have a temperature higher than the elevated temperature. As tested, a two degree (F.) increase in temperature can ensure that the outline of the alphanumeric shape is viewable by the thermal-imaging cameras by several manufactures.

In typical embodiments, the aperture/pocket is filled with air. In alternative embodiments, the pocket/aperture is filled with another fluid such as a gas selected for enhanced thermal-imaging properties. In such alternative embodiments, a sealing material can be provided around the peripheral edges of the aperture/pocket at the interfaces with the front and back layers. In still a further alternative embodiment, a pocket of air can be contained completely within a volume defined by an internal panel, for example by molding a structure with an internal void. Alternatively still, an internal panel can comprise a punchout volume that can be covered with a single material, for example a fire-retardant material.

The signage or placard systems, or signs or placards, can be secured at a height of about twenty-four inches off the ground, however alternate heights higher or lower can be effective. The purpose of a preferred height is so that the sign or placard will be visible below a layer of rising smoke, and high enough to be visible by firemen crawling or kneeling beneath a smoke layer. Further, each sign or placard is secured to a structure preferably no more than about fifty feet from another example sign or placard.

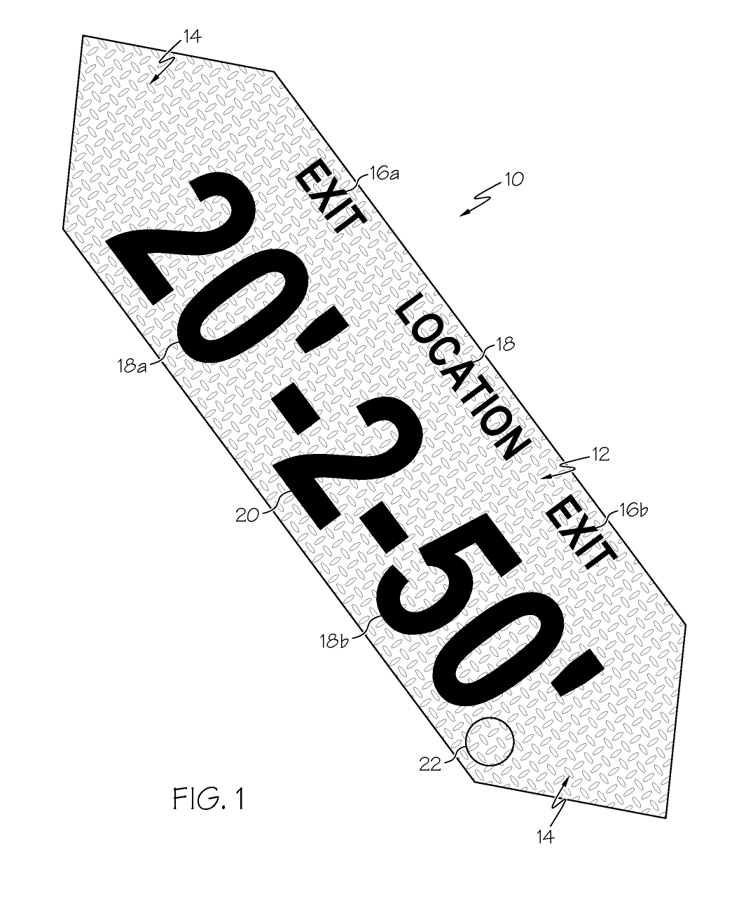

With particular reference to the figures, FIG. 1 shows a first example sign or placard 10 as it can appear mounted to a wall. This first example is organized in a horizontal direction. As shown, the example placard 10 comprises a body with two arrow structures 14 on either end each pointed in opposite directions. The example placard 10 further comprises photo-illuminescent material 12 that additionally comprises a plurality of zig-zag oriented reflectors 22. As further shown, the example placard 10 comprises visual indicators secured to the photo-illuminescent material 12. For example, such visual indicators can include the words “EXIT” 16a, 16b and LOCATION 18 as well as numbers 18a, 18b, 20.

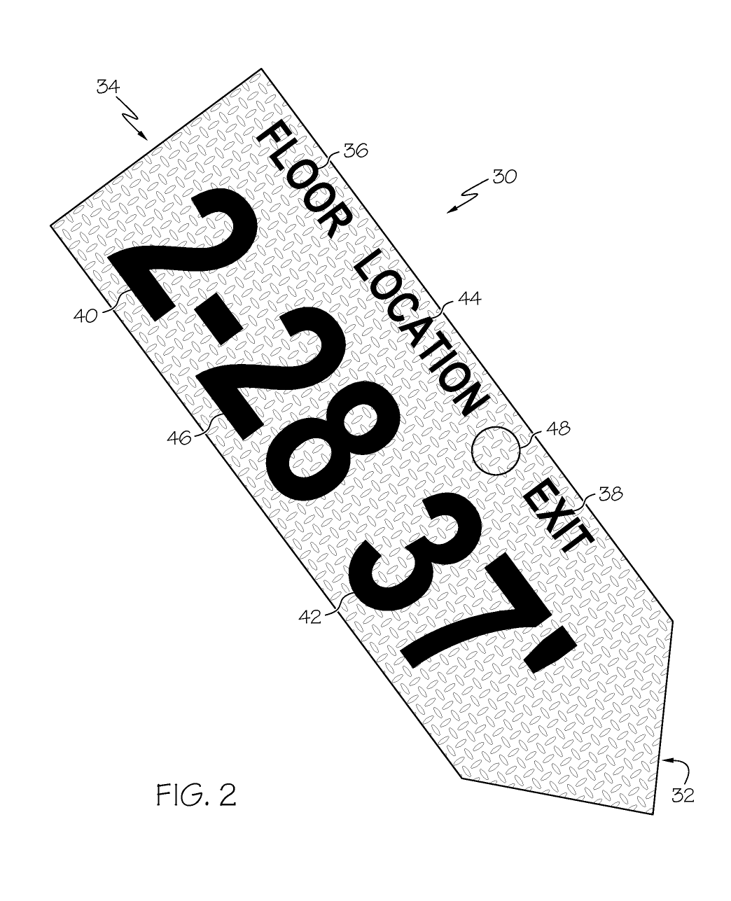

FIG. 2 shows a second alternative example embodiment comprising a placard 30 with an arrow shaped end 32 and a flat back end 34. This second alternative example embodiment comprises photo-illuminescent material with reflectors 48 and a plurality of indicators 36, 38, 40, 42, 44.

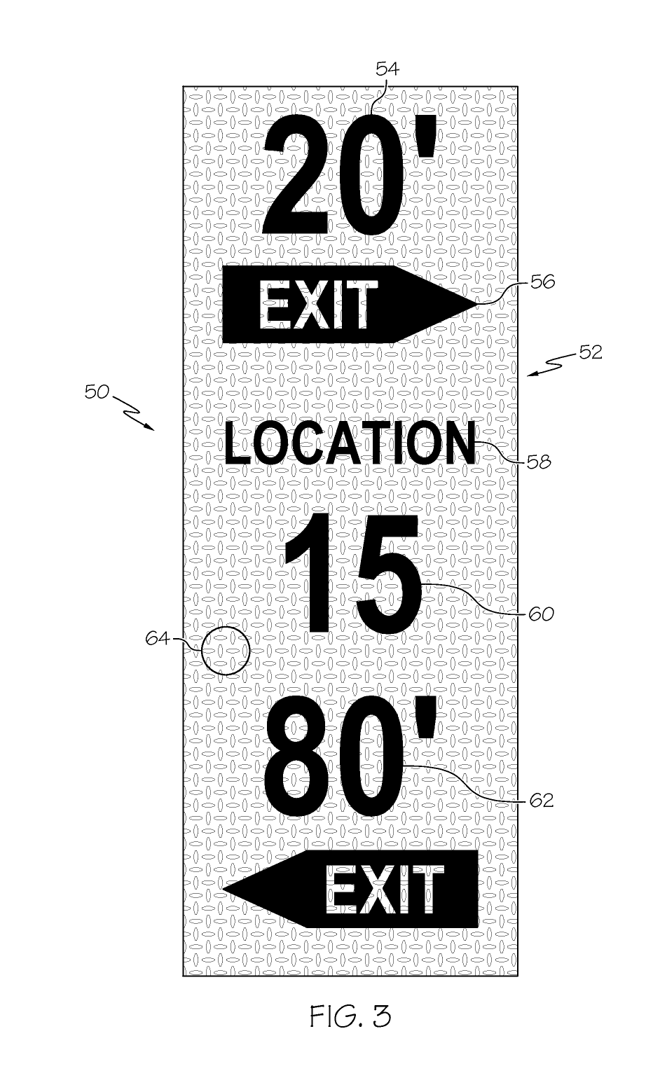

FIG. 3 shows a third alternative example embodiment placard 50 that is mounted vertically. This third alternative example embodiment comprises photo-illuminecent material 52 with reflectors 64 and a plurality of indicators 54, 56, 58, 60, 62.

FIGS. 4 and 6 show an exploded view of the first example embodiment shown in FIG. 1. As shown, the placard comprises a layer of material 66 that comprises the photo-illuminescent material and indicators. As shown in the example embodiment, the layer 66 of fire-retardant photo-illuminescent material can comprise a plurality of solid alphanumeric stickers 76 adhered to an outer surface of the photo-illuminescent material layer for viewing in adequate lighting conditions. An internal metallic material panel 68 is secured beneath the photo-illuminescent material layer 66 with fire-retardant adhesive. The example metallic material panel 68 comprises a similar size and shape to the photo-illuminescent material layer 66 including arrow shapes 72. The metallic material panel 68 comprises alphanumeric shapes 70 cut out. These cut outs 70 create apertures that extend from a front surface to a back surface of the metallic material panel 68. As shown, the alphanumeric cutouts 70 comprise numbers, however, it is contemplated that they could comprise letters and/or shapes. A fire-retardant layer 74 is further shown removed from the metallic surface panel 68 and has a similar shape to the metallic surface panel 68. The fire-retardant layer 74 secures to the back surface of the metallic surface panel 68 with fire-retardant adhesive.

The fire-retardant photo-illuminescent material layer 66 secures to the front surface of the metallic panel 68 with fire-retardant adhesive. And, the fire-retardant material layer 74 secures to the back surface of the metallic surface panel 68 through fire-retardant adhesive. When the photo-illuminescent material layer 66 is secured to the front surface of the metallic material panel 68, and the fire-retardant material layer 74 is secured to the rear surface of the metallic material panel 68 a pocket of air is created in the shape of the alphanumeric cutout 70.

FIG. 5 shows an example pre-plan schematic of a building in which a series of the example placards have been installed in a strategic formation. The pre-plan schematic shows a plurality of exits 80, 82, 84, 86. Within the schematic there is a plurality of placards identified with numbers 1-22. Example placards 1-19 are shown to include an alphanumeric shape and an arrow that indicates in which direction an exit is located. Further placards 20-22 indicate a particular location within the building floor. Preferably, upon arrival at a building that requires emergency action, a firefighting team will have a schematic similar to that shown in FIG. 5. Each fireman who enters the building, therefore, can take such a schematic upon entering the building to assist with navigation and exit of the building. Alternatively, a fireman team leader, who remains outside the building, can communicate directions to a fireman inside the building by requesting that the internal fireman relay his specific location within the building and comparing such location with the schematic.

It should be emphasized that the above described embodiments of the present invention, particularly, any “preferred” embodiments, are merely possible examples of implementations, merely set forth for a clear understanding of the principals of the invention. Many variations and modifications may be made to the above described embodiments of the invention without departing substantially from the spirit and principles of the invention. All such modifications and variations are intended to be included herein within the scope of this disclosure and the present invention and protected by the following claims.

What is claimed:

1. A sign, comprising:
a panel having at least one indicator-shaped aperture therethrough from side to side;
a backing secured to a first surface of the panel, the backing comprising fire-retardant material;
a sheet secured to a second surface of the panel, the sheet comprising fire-retardant material; and
a volume of fluid contained within a space defined by the at least one panel aperture, the backing and the sheet.

2. The sign of claim 1, wherein the panel comprises fire-retardant material.

3. The sign of claim 1, wherein the sheet comprises photo-illuminescent material.

4. The sign of claim 1, wherein the panel comprises metallic material.

5. The sign of claim 1, wherein the sheet comprises vinyl.

6. The sign of claim 1, further comprising fire-retardant adhesive, wherein the backing and the sheet are secured to the panel with the fire-retardant adhesive.

7. The sign of claim 6, wherein the fire-retardant adhesive comprises at least two strips of double-sided tape.

8. The sign of claim 1, wherein the backing comprises a front surface and a back surface, the backing comprising fire-retardant adhesive on each surface.

9. The sign of claim 1, wherein the sheet comprises at least one reflective marking.

10. The sign of claim 1, wherein the at least one aperture comprises an alphanumeric shape.

11. The sign of claim 1, wherein the volume of fluid is adapted to be viewed by a thermal-imaging unit during high-temperature conditions.

12. A sign, comprising:
a panel having at least one alphanumeric aperture therethrough from the front surface to the back surface; and
a volume of fluid defined with respect to the at least one panel aperture.

13. The sign of claim 12, wherein the panel further comprises:
a backing adhered to the panel back surface, the backing comprising flame retardant material; and
a cover adhered to the panel front surface, the cover comprising flame retardant material.

14. The sign of claim 13, wherein the cover comprises photo-illuminescent material.

15. The sign of claim 13, wherein the backing and cover are adhered to the panel with a flame-retardant adhesive.

16. The sign of claim 15, wherein the flame-retardant adhesive comprises at least two strips of double-sided tape.

17. The sign of claim 13, wherein the backing comprises a front surface and a back surface, the backing comprising flame-retardant adhesive on each surface.

18. The sign of claim 13, wherein the cover comprises at least one reflective marking.

19. The sign of claim 13, wherein the cover comprises vinyl.

20. A sign, comprising:
a fire-retardant panel having at least one alphanumeric aperture therethrough;
a backing adhered to the panel back surface, the backing comprising flame-retardant material;
a photo-illuminescent material adhered to the panel front surface, the photo-illuminescent material comprising flame retardant material and at least one reflective marking; and
a pocket of fluid contained within a volume defined by the at least one fire-retardant panel aperture, the backing and the photo-illuminescent material, the pocket of air adapted to be viewed by a thermal-imaging unit in high-temperature conditions.
